(19) United States
(12) Patent Application Publication
(10) Pub. No.: US 2010/0301515 A1
(43) Pub. Date: Dec. 2, 2010

(54) Honeycomb Extrusion Die Apparatus And Methods

(76) Inventors: Thomas William Brew, Corning, NY (US); Keith Norman Bubb, Watkins Glen, NY (US); Michael James Lehman, Canisteo, NY (US)

Correspondence Address: CORNING INCORPORATED, SP-TI-3-1, CORNING, NY, 14831, US

(21) Appl. No.: 12/474,820

(22) Filed: May 29, 2009

(51) Int. Cl. B29C 47/30; B23P 21/00; B23P 11/00

(52) U.S. Cl. 264/177.12; 425/467; 29/469; 29/428

(57) ABSTRACT

A die apparatus and methods of making a die body can provide a skin slot extending through a honeycomb network and an end portion of a plurality of pins, wherein the skin slot includes opposed sides that are each in fluid communication with the honeycomb network. In further embodiments, methods are provided for co-extruding a honeycomb body and an integral skin with a die body including a skin slot.

### FIELD

The present disclosure relates generally to die apparatus and methods, and more particularly, to die apparatus and methods for co-extruding a honeycomb body and an integral skin.

### BACKGROUND

Conventional methods for the extrusion of honeycomb bodies include extrusion dies that co-extrude the skin and the honeycomb body. However, the skin may not attach sufficiently to the honeycomb body. As such, the extruded part may need to be discarded, or undergo further processing techniques.

### SUMMARY

In one example, a honeycomb extrusion die apparatus comprises a die body including an array of pins that are spaced apart to define a honeycomb network of discharge slots. The die apparatus also comprises a skin slot extending through the honeycomb network and an end portion of a plurality of the pins. The skin slot includes opposed sides that are each in fluid communication with the honeycomb network.

In another example, a method is provided for making a die body configured to co-extrude a honeycomb body and an integral skin. The method comprises the steps of providing an array of pins that are spaced apart to define a honeycomb network of discharge slots; and subsequently, providing a skin slot. The skin slot extends through the honeycomb network and an end portion of a plurality of the pins. The skin slot includes opposed sides that are each in fluid communication with the honeycomb network.

In another example, a method is provided for co-extruding a honeycomb body and an integral skin with a honeycomb extrusion die apparatus. The honeycomb extrusion die apparatus includes a die body with an array of pins that are spaced apart to define a honeycomb network of discharge slots. A skin slot passes through the honeycomb network and an end portion of a plurality of the pins. The skin slot includes opposed sides that are each in fluid communication with the honeycomb network. The honeycomb extrusion die apparatus further includes a mask member. The method comprises the steps of mounting the mask member with respect to the die body to cover an outer portion of the honeycomb network. The method also comprises extruding batch material through the die body such that the honeycomb body is formed by an inner portion of the honeycomb network. The integral skin is formed by batch material passing through a plurality of the discharge slots in fluid communication with the skin slot.

### BRIEF DESCRIPTION OF THE DRAWINGS

These and other features, aspects and advantages of the present disclosure are better understood when the following detailed description is read with reference to the accompanying drawings, in which:

FIG. 1 is a top schematic view of an example die body of a honeycomb extrusion die apparatus;

FIG. 2 is a top schematic view of a mask positioned with respect to the die body of FIG. 1;

FIG. 3 is a partial cross-sectional view of the honeycomb extrusion die apparatus along line 3-3 of FIG. 2 with a portion of a batch material entering feed holes of the die body;

FIG. 3A is a partial cross-sectional view of the die body along line 3A-3A of FIG. 3;

FIG. 4 is an enlarged view of a portion of the honeycomb extrusion die apparatus of FIG. 3;

FIG. 5 is a schematic illustration of an enlarged portion of a die body with a skin slot being formed by an electronic discharge machining process;

FIG. 6 is a partial cross-sectional view of the honeycomb extrusion die apparatus of FIG. 3 with the portion of the batch material continuing to pass through the feed holes and entering discharge slots and the skin slot of the die body;

FIG. 6A is a partial cross-sectional view of the die body along line 6A-6A of FIG. 6;

FIG. 7 is a partial cross-sectional view of the honeycomb extrusion die apparatus of FIG. 6 with the portion of the batch material completely passing through the discharge slots and the skin slot and exiting the die body as a co-extrusion of a honeycomb body and an integral skin; and

FIG. 7A is a partial cross-sectional view of the die body along line 7A-7A of FIG. 7.

### DETAILED DESCRIPTION

Example descriptions will now be described with reference to the accompanying drawings in which example embodiments of the disclosure are shown. Whenever possible, the same reference numerals are used throughout the drawings to refer to the same or like parts. However, examples may be embodied in many different forms and should not be construed as limited to the examples set forth herein.

A honeycomb body and integral skin can be formed from a wide variety of batch materials such as cement mixtures. Example cement mixtures can include a paste and/or slurry, such as particles and/or powders mixed with polymer binders and/or low molecular weight liquids and combinations of these and other materials, such as for forming a cement slurry. Descriptions of example materials that may be used for the cement mixture and/or to fabricate the honeycomb body and integral skin can be found in numerous patents and patent applications. Example ceramic batch material compositions including cordierite are disclosed in U.S. Pat. Nos. 3,885,977; RE 38,888; 6,368,992; 6,319,870; 6,210,626; 5,183,608; 5,258,150; 6,432,856; 6,773,657; 6,864,198; and U.S. Patent Application Publication Nos. 2004/0029707, 2004/0261384, and 2005/0046063. Examples ceramic batch material compositions for forming aluminum titanate are those disclosed in U.S. Pat. Nos. 4,483,944; 4,855,265; 5,290,739; 6,620,751; 6,942,713; 6,849,181; U.S. Patent Application Publication Nos.: 2004/0020846; 2004/0092381; and in PCT Application Publication Nos. WO 2006/015240; WO 2005/046840; and WO 2004/011386.

As set forth in the figures, example honeycomb extrusion die apparatus and methods are provided to allow co-extruding a honeycomb body and integral skin. Honeycomb bodies can include various structures defining a network of cells, whatever the geometry of the cells may be. For example, the cells can comprise curvilinear cells, such as circular, oval or other curvilinear shapes. In further examples, the cells can comprise triangular, rectangular (e.g., square) or other polygonal shapes. Honeycomb bodies can be used in various filtering applications, including, for example, particulate filters for processing exhaust from a combustion engine.

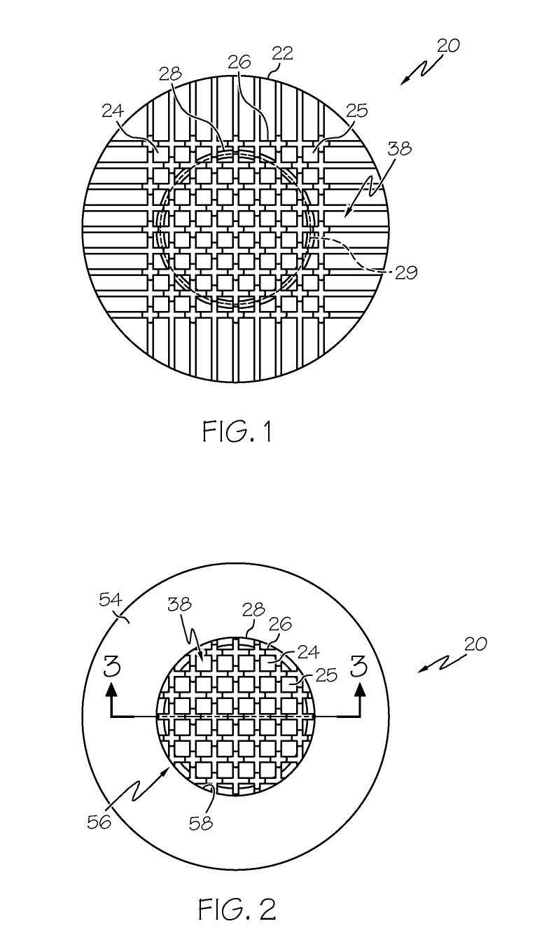

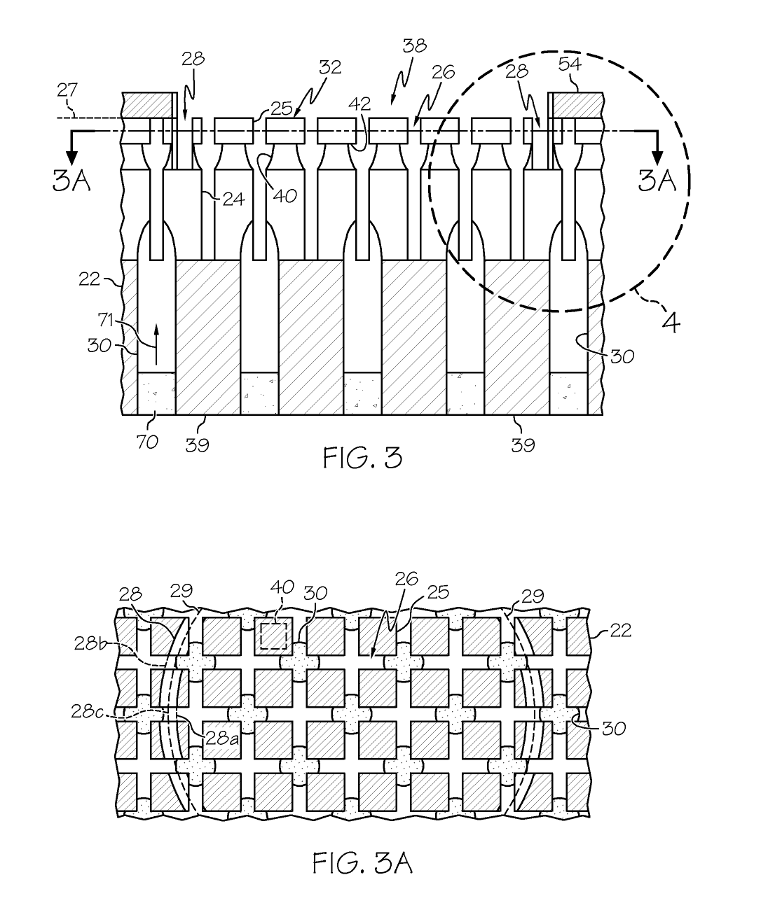

FIG. 1 provides a top schematic illustration of a honeycomb extrusion die apparatus 20 comprising an example die body 22. The die body 22 includes an array of pins 24 that can be provided with an end portion 25 terminating with a substantially flat end surface 32. As shown in FIG. 3, the each substantially flat end surface 32 can extend along a common plane 27 to present a generally flat surface across an outlet face 38 of the die body 22. In further examples, one or more of the end surfaces may extend along different planes, may be nonplanar and/or arranged in a nonplanar fashion.

Each end portion 25 can include a variety of alternative peripheral shapes and sizes to produce a wide range of honeycomb channels. As shown, in FIGS. 1, 2 and 3A, the end portion 25 of each pin 24 can include a substantially square shape although one or more of the end portions may have other rectangular shapes, triangular shapes and/or other polygonal shapes. In addition or alternatively, one or more of the end portions 25 can have a circular, oval, or other curvilinear shape. As illustrated, the pins 24 can be substantially identical to one another and have substantially the same size. In further examples, the pins can have different shapes and/or sizes. For example, certain pins may have an end portion with a curvilinear shape while other end portions have a polygonal shape. In still further examples, the pins may comprise geometrically similar shapes with different sizes. For instance, the end portions may have substantially the same geometric shape with a size that increases or decreases in a radial direction from the central axis of the die body 22.

As illustrated, the array of pins 24 can be distributed as a matrix of pins with equally spaced rows and columns such that the pins are uniformly spaced along a given row and a given column. Alternatively, the pins 24 can be distributed in various other array patterns such as uneven rows/columns or randomly, and/or non-uniformly across a given row and/or column. The pins 24 are spaced apart to define a honeycomb network of discharge slots 26. The honeycomb network of discharge slots 26 can have a wide variety of patterns depending on the arrangement and characteristics of the end portions 25 of the respective pins 24. For example, the illustrated discharge slots 26 can be provided with substantially the same width to provide a uniform rectilinear matrix at an outlet face 38 of the die body 22. Such a configuration can produce a honeycomb body with substantially the same wall thickness. In another example, the network may include slots with differing dimensions to produce a honeycomb body with different wall thicknesses. For instance, the honeycomb extrusion die apparatus can be designed to produce a honeycomb body where the thicknesses of the walls increase or decrease based on the radial distance from the central axis of the honeycomb body.

Referring to FIG. 3, at least one pin 24 of the array of pins may include a divot 40 located at a depth from the end surface 32 of the at least one pin 24. As shown FIG. 3A, hidden lines demonstrate that the divot 40 can completely surround the corresponding pin 24 although the divot may not surround or completely surround the pins in further examples. For instance, a single side of a pin may be provided with one or more divots or a plurality of sides may each be provided with one or more divots that may or may not be connected to one another. Still further, the divot may be provided with a wide range of shapes and sizes. For instance, the divot may comprise one or more recesses or grooves. Example grooves can comprise a U-shaped, V-shaped, C-shaped or other groove configuration. As shown, the divot 40 comprises a single groove surrounding the pin 24 that tapers inwardly in a downstream direction. As shown, the inward taper increases in depth to a maximum depth ending at a shoulder 42 of the end portion 25.

The honeycomb extrusion die apparatus 20 further includes a skin slot 28 extending through the honeycomb network of discharge slots 26 and an end portion 25 of a plurality of the pins 24. As shown in FIGS. 1 and 3A, the skin slot 28 may be substantially continuous along a path 29 of the skin slot. Thus, the illustrated skin slot 28 is considered continuous as the skin slot 28 alternates between passing through end portions 25 of the corresponding pins 24 and the discharge slots 26 disposed between the corresponding pins 24. As shown in FIG. 3A, at the location of the discharge slots 26, opposed sides 28a, 28b of the skin slot can be arranged in fluid communication with the honeycomb network of discharge slots 26. Indeed, at the location of the discharge slots 26, the illustrated skin slot 28 includes a radial inner side 28a in fluid communication with the honeycomb network of discharge slots 26. Likewise, at the location of the discharge slots 26, the illustrated skin slot 28 includes an opposed radial outer side 28b in fluid communication with the honeycomb network of discharge slots 26. As further shown, at the location of the discharge slots 26, the skin slot 28 can include a bottom portion 28c in fluid communication with the honeycomb network of discharge slots 26. As described more fully below, providing a skin slot 28 with features set forth herein can facilitate effective co-extrusion of a honeycomb body and integral skin.

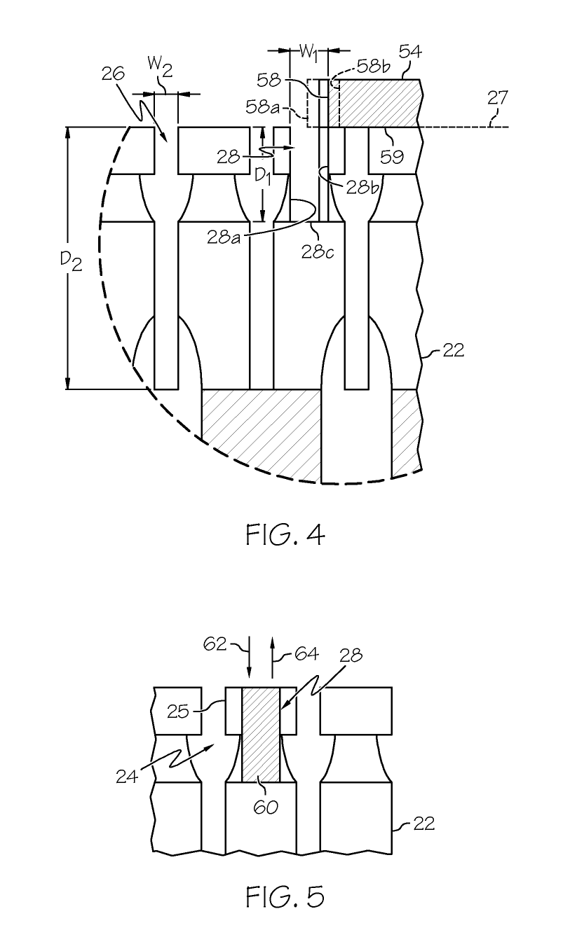

Referring to FIG. 4, the skin slot 28 may have a width W₁ that is greater than the width W₂ of the discharge slots 26. The width W₁ of the skin slot 28 can be predetermined based on the desired final thickness of the skin while considering expected shrinkage of the batch material after the co-extrusion technique. In examples applications, the skin slot 28 may have a depth D₁ that is at least five times a width W₁ of the skin slot 28 in order to allow complete formation of the skin and integration of the skin with the honeycomb body. In further examples the skin slot depth D₁ may be more or less than five times the width W₁ of the skin slot depending on the batch material composition, process parameters and/or other considerations.

The depth D₁ of the skin slot 28 may be greater than or equal to the depth D₂ of the skin slot 28. Alternatively, as illustrated, the skin slot 28 may have a depth D₁ that is less than a depth D₂ of the discharge slots 26. For instance, in applications where at least one pin 24 of the array of pins includes a divot 40, the skin slot 28 may extend through the end portion 25 of the at least one pin 24 to the depth of the divot 40. As shown, the skin slot 28 extends to the downstream end of the divot 40 where the batch material first encounters the divot 40. In further examples, the skin slot 28 may extend to an intermediate portion of the divot or to the upstream end of the divot 40 where the batch material leaves the divot 40. It will also be appreciated that the skin slot 28 may not extend to the divot or may extend past the divot in further examples.

As shown in FIG. 2, the honeycomb extrusion die apparatus 20 may further comprise a mask member 54 mounted with respect to the die body to cover an outer portion of the honeycomb network of discharge slots 26. The mask member can be mounted in many ways including clamping mechanisms or the like. In the illustrated example, the mask member 54 is configured to be removably attached with respect to the die body 22. As shown, the mask member 54 can include a unitary structure although the mask member may comprise a plurality of portions mounted with respect to one another to provide the desired masking configuration. The mask member 54 may have a variety of shapes and sizes depending on the particular application. In the illustrated embodiment, the mask member 54 includes an opening 56 that is completely surrounded by the outer portions of the mask member 54. In further examples, the opening 56 may be open to one or more areas of the outer periphery of the mask member. Furthermore, the opening 56 includes a circular shape although the opening may have an oval or other curvilinear shape. In addition or alternatively, the opening 56 may have a triangular, rectangular (e.g., square) or other polygonal shape. As shown in FIG. 2, the opening 56 can be provided with a peripheral edge 58 configured to be oriented with respect to the skin slot 28. As shown in FIG. 4, the peripheral edge 58 can be aligned with the outer side 28b of the skin slot 28 when the mask member 54 is mounted with respect to the die body 22. In further examples, the peripheral edge 58 may be positioned out of alignment with the outer side 28b of the skin slot 28. For example, as shown in hidden lines in FIG. 4, the peripheral edge 58a may extend radially inward with respect to the outer side 28b of the skin slot 28. As further shown in hidden lines, the peripheral edge 58b may extend radially outward with respect to the outer side 28b of the skin slot 28.

FIG. 5 is a schematic illustration of the skin slot 28 being machined into the end portion 25 of a pin 24. As shown, an electrical discharge machining component 60 can be plunged in direction 62 to machine the skin slot. Then the component 60 can be removed in direction 64. Once removed, the skin slot 28 remains and can be configured as described more fully above. While electrical discharge machining (EDM) is illustrated, it will be appreciated that a wide range of other machining techniques may be employed to provide the skin slot 28. For example, the skin slot may be formed by grinding, boring or other machining methods. Furthermore, the skin slot may be formed by chemical processes or other nonmachining methods.

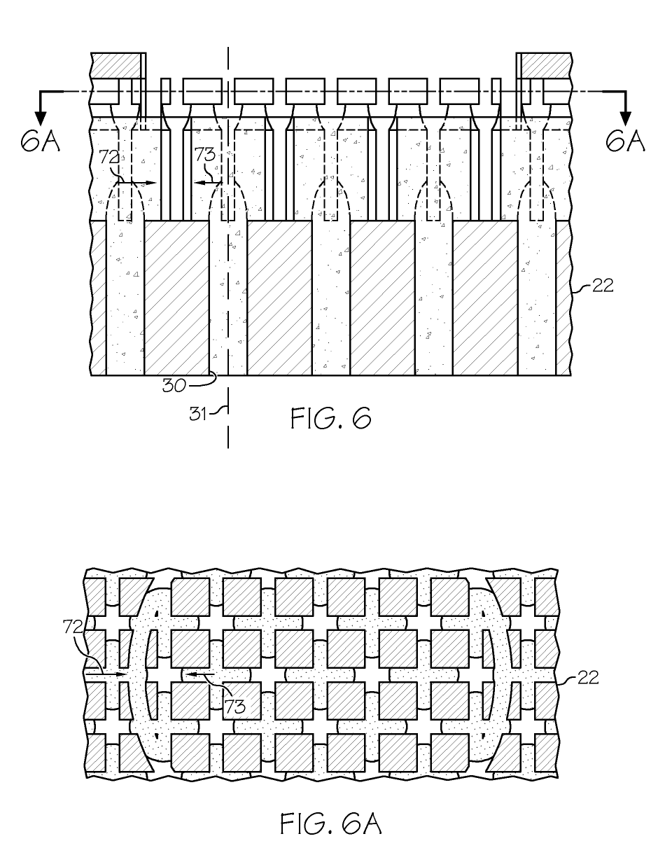

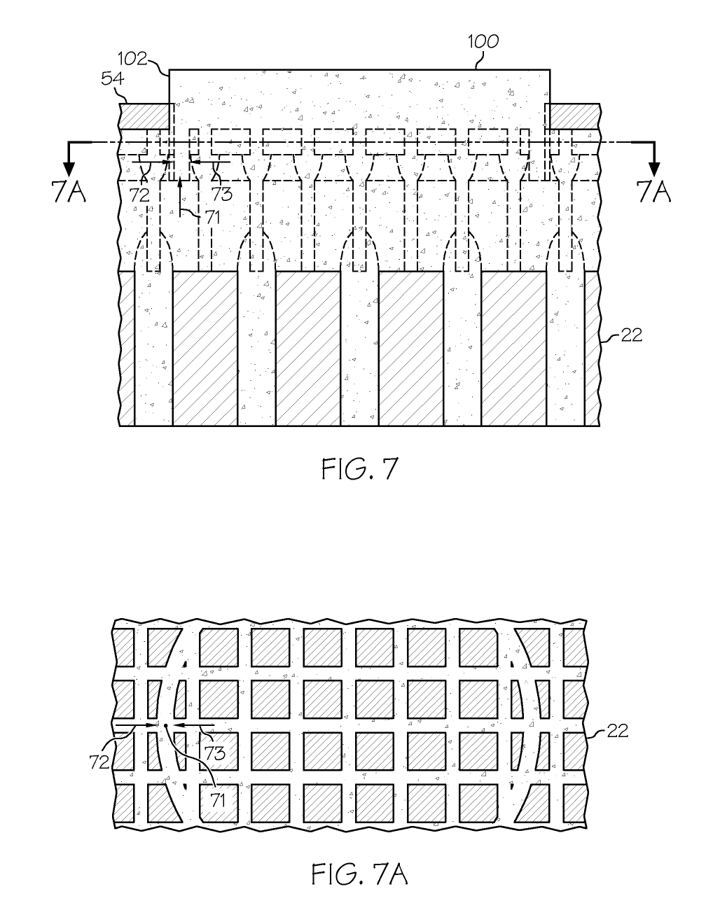

A method of co-extruding a honeycomb body 100 will now be described with reference to FIGS. 3, 3A, 6, 6A, 7 and 7A. With respect to FIGS. 6 and 7, portions of the pins 24 hidden by the batch material 70 are shown in broken lines for clarity. As shown in FIG. 3, the die body 22 can include feed holes 30 for providing communication between an inlet face 39 and the discharge slots 26. As shown in FIG. 3A, the feed holes 30 may be offset for direct fluid communication with every other discharge slot intersection along each row and each column of slots. Referring to FIG. 2, the mask member 54 may be mounted with respect to the die body 22 to cover the outer portion of the honeycomb network of discharge slots 26. As shown in FIG. 4, the mask member 54 can include flat lower surface 59 configured to rest along the common plane 27. The mask member 54 can then be positioned such that the opening 56 is positioned with respect to the inner portion of the honeycomb network of discharge slots. As shown in FIG. 4, in one example, the peripheral edge 58 of the opening 56 can be aligned with the outer side 28b of the skin slot 28. Once appropriately positioned, the mask member 54 can be mounted with respect to the die body 22.

The batch material 70 can then be extruded through the die body 22. Indeed, as shown in FIG. 3, batch material can be first introduced through the feed holes 30 and flows upward in direction 71 to the honeycomb network of discharge slots 26. The batch material 70 then reaches the skin slots 28 and begins to spread radially away from the axis of each respective feed hole 30.

As shown in FIGS. 6 and 6A, once the batch material 70 reaches discharge slots 26, the material begins to spread radially away from the axis 31 of each respective feed hole 30. As further shown in FIG. 6, the batch material 70 flows through each opposed side 28a, 28b and the bottom portion 28c of the skin slot 28 after initially flowing through a lower portion of the discharge slots 26. Directional arrow 72 in FIGS. 6 and 6A demonstrates that batch material can travel through the radial outer side 28b of the skin slot 28 from the outer portion of the honeycomb network of discharge slots 26. Directional arrow 73 in FIGS. 6 and 6A also illustrates that the batch material can travel through the radial inner side 28a of the skin slot 28 from the inner portion of the honeycomb network of discharge slots 26. As show, the batch material 70 can encounter the divots 40 of the respective pins 24. The divots 40, if provided, can present an accumulation zone to help distribute the batch material as the integral skin 102 is formed.

As shown in FIGS. 7 and 7A, the honeycomb body 100 is formed by an inner portion of the honeycomb network and an integral skin 102 is formed by the batch material 70 passing through the plurality of discharge slots 26 in communication with the skin slot 28. As shown in FIG. 7, the mask member 54 covers the outer portion of the honeycomb network to prevent batch material 70 from extruding axially through the outer portion of the die body 22. Moreover, the mask member 54 forces material from the outer portion of the honeycomb network to travel in direction 72 radially inward towards the skin slot 28.

As mentioned previously, each opposed side 28a, 28b of the skin slot 28 is in fluid communication with the honeycomb network of discharge slots 26. As such, batch material 70 may enter the skin slot 28 from opposite radial sides 28a, 28b of the skin slot 28 as well as the bottom portion 28c of the skin slot 28. Such a skin slot configuration enhances pressure as batch material forced in an outward radial direction 73 is countered by batch material forced in an inward radial direction 72. The resulting pressure can enhance integration of the integral skin 102 with the honeycomb body 100.

As shown, the method can initially form the integral skin 102 substantially entirely by the skin slot 28 without interaction by the mask member 54. Such a configuration may reduce interaction with the mask member 54 that may otherwise promote surface imperfections of the integral skin 102 and/or generate forces tending to pull the integral skin away from the honeycomb body. To further avoid interaction, the peripheral edge 58b may be offset away from the outer side 28b of the skin slot 28 as shown in FIG. 4. In alternative configurations, it may be desirable to interact the integral skin 102 with the peripheral edge as the co-extruded honeycomb body and integral skin leave the outlet face 38 of the die body 22. For example, as shown in FIG. 4, the peripheral edge 58a may extend radially inward with respect to the outer side 28b of the skin slot 28. Such an arrangement may further increase pressure within the skin slot 28 and thereby result in improved integration of the integral skin 102 with the honeycomb body 100.

As further illustrated, a portion of the batch material may initially pass through a portion of the honeycomb network and then subsequently pass through the skin slot 28 to form the integral skin. For instance, as shown in FIG. 6, the batch material is first extruded through the feed holes 30. The batch material then reaches the discharge slots 26 and begins to form the honeycomb network. Portions of the initially formed honeycomb network then enter the skin slot 28 to form the integral skin 102. Finally, the batch material is extruded past the outlet face 38 of the die body 22 where the skin and honeycomb structure are co-extruded to form one, continuous honeycomb body.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

What is claimed is:

1. A honeycomb extrusion die apparatus comprising:
a die body including an array of pins that are spaced apart to define a honeycomb network of discharge slots, and a skin slot extending through the honeycomb network and an end portion of a plurality of the pins, wherein the skin slot includes opposed sides that are each in fluid communication with the honeycomb network.

2. The apparatus of claim 1, wherein each pin of the array of pins includes an end surface positioned on a common plane.

3. The apparatus of claim 1, wherein at least one pin of the array of pins includes a divot located at a depth from an end surface of the at least one pin.

4. The apparatus of claim 3, wherein the skin slot extends through the end portion of the at least one pin to the depth of the divot.

5. The apparatus of claim 3, wherein the divot surrounds the at least one pin.

6. The apparatus of claim 1, wherein the skin slot is substantially continuous along a path of the skin slot.

7. The apparatus of claim 1, wherein the skin slot has a width that is greater than a width of the discharge slots.

8. The apparatus of claim 1, wherein the skin slot has a depth that is at least five times a width of the skin slot.

9. The apparatus of claim 1, wherein the skin slot has a depth that is less than a depth of the discharge slots.

10. The apparatus of claim 1, further comprising a mask member configured to be mounted with respect to the die body to cover an outer portion of the honeycomb network.

11. The apparatus of claim 10, wherein the mask member includes an opening with a peripheral edge configured to be aligned with an outer side of the skin slot when the mask member is mounted with respect to the die body.

12. A method of making a die body configured to co-extrude a honeycomb body and an integral skin, the method comprising the steps of:
providing an array of pins that are spaced apart to define a honeycomb network of discharge slots; and subsequently,
providing a skin slot extending through the honeycomb network and an end portion of a plurality of the pins, wherein the skin slot includes opposed sides that are each in fluid communication with the honeycomb network.

13. The method of claim 12, wherein the step of providing the skin slot includes machining the skin slot into the end portion of the plurality of pins.

14. The method of claim 13, wherein the step of machining comprises electrical discharge machining.

15. The method of claim 13, wherein skin slot is machined to a depth that is less than a depth of the discharge slots.

16. The method of claim 12, wherein at least one pin of the array of pins includes a divot located at a depth from an end surface of the at least one pin.

17. The method of claim 16, wherein the divot surrounds the at least one pin.

18. A method of co-extruding a honeycomb body and an integral skin with a honeycomb extrusion die apparatus including a die body with an array of pins that are spaced apart to define a honeycomb network of discharge slots, a skin slot passing through the honeycomb network and an end portion of a plurality of the pins, wherein the skin slot includes opposed sides that are each in fluid communication with the honeycomb network, and a mask member, the method comprising the steps of:
mounting the mask member with respect to the die body to cover an outer portion of the honeycomb network; and
extruding batch material through the die body such that the honeycomb body is formed by an inner portion of the honeycomb network and the integral skin is formed by batch material passing through a plurality of the discharge slots in fluid communication with the skin slot.

19. The method of claim 18, wherein the integral skin is initially formed substantially entirely by the skin slot.

20. The method of claim 18, wherein a portion of the batch material travels through a radial outer side of the skin slot from the outer portion of the honeycomb network.
